(19) United States
(12) Patent Application Publication
(10) Pub. No.: US 2010/0092747 A1
(43) Pub. Date: Apr. 15, 2010

(54) INFRARED-REFLECTING FILMS AND METHOD FOR MAKING THE SAME

(75) Inventors: Yip-Wah Chung, Wilmette, IL (US); Michael Graham, Evanston, IL (US); Alpana Ranade, Evanston, IL (US)

Correspondence Address: NovaTech IP Law, 1001 Ave. Pico, Suite C500, San Clemente, CA, 92673, US

(73) Assignee: NORTHWESTERN UNIVERSITY, Evanston, IL (US)

(21) Appl. No.: 12/251,333

(22) Filed: Oct. 14, 2008

(51) Int. Cl. B32B 18/00; B32B 13/00; B32B 15/00

(52) U.S. Cl. 428/220; 428/702; 428/457; 428/426; 428/446

(57) ABSTRACT

There is provided single layer infrared-reflecting films and a method of making the same that provide enhanced reflectivity in an 800 nanometer to 2500 nanometer infrared waveband. The method comprises providing a substrate, depositing onto the substrate a mixture of an oxide matrix material and either a conductive metal dopant or a higher valence cation, and producing the infrared-reflecting film.

### BACKGROUND OF THE DISCLOSURE

1) Field of the Disclosure

The disclosure relates to infrared-reflecting films. In particular, the disclosure relates to single layer infrared-reflecting films and a method of making the same wherein the films provide enhanced reflectivity in an 800 nanometer to 2500 nanometer infrared waveband.

2) Description of Related Art

Nearly 50% of incident solar power falls in the infrared (IR) waveband from 800 nanometers (nm) to 2500 nanometers (nm) in wavelength. It is therefore desirable to use infrared-reflecting films to enhance reflectivity in the IR waveband. Known infrared-reflecting films and methods for making the same exist. Such known infrared-reflecting films are typically manufactured using multilayers of two or more components with well-defined optical properties. The working principle is based on either optical interference or additive properties of individual components. Such multilayer films are typically synthesized by known techniques such as physical vapor deposition, chemical vapor deposition, or a sol-gel method. However, the manufacture of multiple layers can result in increased expense, complexity, and time to manufacture. Such multilayer films may not be suitable for industrial-scale processes due to higher costs. In addition, in the case of known interference films, interference between different layers may cause a colored appearance that is undesirable in certain applications.

Accordingly, there is a need for infrared-reflecting films and a method of making the same that provide advantages over known films and methods.

### SUMMARY OF THE DISCLOSURE

This need for improved infrared-reflecting films and a method of making the same is satisfied. None of the known films and methods provide all of the numerous advantages discussed herein. Unlike known films and methods, embodiments of the films and method of the disclosure may provide one or more of the following advantages: provides for single layer infrared-reflecting films and method for making the same that are simple, less expensive and time-consuming to make, and are suitable for industrial-scale manufacturing; provides for single layer infrared-reflecting films and method for making the same that use uniquely doped materials to reflect infrared radiation, transmit visible light, and absorb ultraviolet light to minimize degradation of materials; and provides for single layer infrared-reflecting films and method for making the same that enhance reflectivity in the 800 nm to 2500 nm IR waveband and reflect over a wide range of wavelengths and do not cause a colored appearance.

In one of the embodiments of the disclosure, there is provided a method for making a single layer infrared-reflecting film comprising the steps of: providing a substrate; depositing onto the substrate a mixture of an oxide matrix material and a conductive metal dopant; and, producing the infrared-reflecting film. The oxide matrix material may comprise titanium dioxide, zinc oxide, tin oxide, or another suitable oxide matrix material. The conductive metal dopant may comprise gold, silver, copper, or another suitable conductive metal dopant.

In another embodiment of the disclosure, there is provided a method for making a single layer infrared-reflecting film comprising the steps of: providing a substrate; depositing onto the substrate a mixture of an oxide matrix material and a higher valence cation; and, producing an infrared-reflecting film. The oxide matrix material may comprise titanium dioxide, zinc oxide, tin oxide, or another suitable oxide matrix material. The higher valence cation may comprise niobium, vanadium, tantalum, tungsten, chromium, or another suitable higher valence cation.

In another embodiment of the disclosure, there is provided a single layer infrared-reflecting film with enhanced reflectivity in an 800 nanometer to 2500 nanometer infrared waveband, the film comprising a mixture of an oxide matrix material and a conductive metal dopant over a substrate. The oxide matrix material may comprise titanium dioxide, zinc oxide, tin oxide, or another suitable oxide matrix material. The conductive metal dopant may comprise gold, silver, copper, or another suitable conductive metal dopant.

In another embodiment of the disclosure, there is provided a single layer infrared-reflecting film with enhanced reflectivity in an 800 nanometer to 2500 nanometer infrared waveband, the film comprising a mixture of an oxide matrix material and a higher valence cation over a substrate. The oxide matrix material may comprise titanium dioxide, zinc oxide, tin oxide, or another suitable oxide matrix material. The higher valence cation may comprise niobium, vanadium, tantalum, tungsten, chromium, or another suitable higher valence cation.

The features, functions, and advantages that have been discussed can be achieved independently in various embodiments of the present disclosure or may be combined in yet other embodiments further details of which can be seen with reference to the following description and drawings.

### BRIEF DESCRIPTION OF THE DRAWINGS

The disclosure can be better understood with reference to the following detailed description taken in conjunction with the accompanying drawings which illustrate preferred and exemplary embodiments, but which are not necessarily drawn to scale, wherein:

FIG. 1 is a schematic diagram of one of the embodiments of a deposition apparatus that may be used to produce the infrared-reflecting films of the disclosure;

FIG. 2 is a cross-sectional view of one of the embodiments of the infrared-reflecting films of the disclosure;

FIG. 3 is a cross-sectional view of another one of the embodiments of the infrared-reflecting films of the disclosure;

FIG. 4 is a block flow diagram of one of the embodiments of the method of the disclosure;

FIG. 5 is a block flow diagram of another one of the embodiments of the method of the disclosure;

FIG. 6 is a graph showing percent reflectivity of one of the embodiments of the infrared-reflecting films containing gold; and,

FIG. 7 is a graph showing percent reflectivity of one of the embodiments of the infrared-reflecting films containing niobium.

### DETAILED DESCRIPTION OF THE DISCLOSURE

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

The infrared-reflecting films and method of the disclosed embodiments may be used in connection with enhancement of reflectivity in the 800 nm to 2500 nm infrared (IR) waveband. Accordingly, one of ordinary skill in the art will recognize and appreciate that the infrared-reflecting films and method of making the same of the disclosure can be used in any number of applications where enhancement of reflectivity in the 800 nm to 2500 nm IR waveband is desired.

The invention uses the principles of bulk and interface plasma resonance to create film materials that reflect IR radiation. When charged particles such as electrons are illuminated with electromagnetic (EM) radiation with a frequency less than a certain critical value, they are driven into acceleration and deceleration by the electric field of the incident EM waves at the same frequency. This, in turn, results in the emission of EM radiation at the same frequency. This is the origin of enhanced reflection of EM radiation by the medium of charged particles. The critical frequency is directly related to the dielectric properties of the medium. The single layer films disclosed are transparent to visible light and reflect IR radiation. The films demonstrate a 25-30% reflectivity of incident solar energy, which can result in a significant reduction in energy transmission through the films.

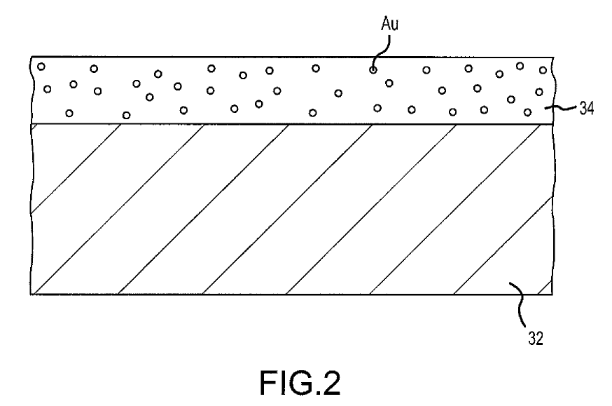

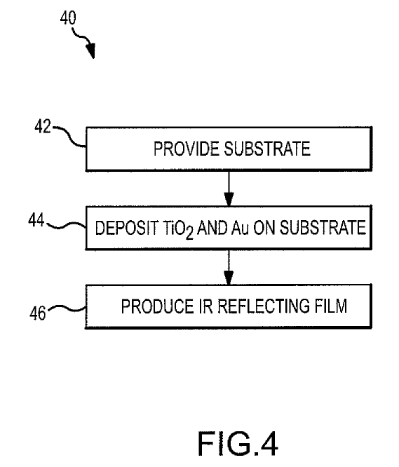

In one of the embodiments of the disclosure there is provided a method for making a single layer infrared-reflecting film. Preferably, the film is transparent. FIG. 2 is a cross-sectional view of one of the embodiments of the infrared-reflecting films of the disclosure. FIG. 2 shows a substrate 32 and a single layer 34 comprising a mixture of an oxide matrix material and a conductive metal dopant, such as gold (Au), discussed in further detail below. FIG. 4 is a block flow diagram of one of the embodiments 40 of the method of the disclosure. The method of this embodiment comprises step 42 (FIG. 4) of providing a substrate. The substrate may comprise glass, semiconductor (e.g., silicon), ceramic (including cement-based material), enamel, metal, composite, laminate, or another suitable substrate. The type of substrate used depends on the type of measurements desired and on the type of deposition method and apparatus used. For example, a glass or transparent substrate may be a preferred substrate if reflectivity and transparency is being measured. Silicon may be a preferred substrate if smoothness or roughness of the film is being measured or observed because silicon substrates are very smooth.

The method further comprises step 44 (FIG. 4) of depositing onto the substrate a mixture of an oxide matrix material, such as TiO₂, and a conductive metal dopant. The oxide matrix material may comprise titanium dioxide, zinc oxide, tin oxide, or another suitable oxide matrix material transparent in the visible region. TiO₂ is a preferred oxide matrix material because it is transparent to visible light, inexpensive, stable and nontoxic. The TiO₂ may be a mixture of anatase TiO₂ and rutile TiO₂. The TiO₂ may be substoichiometric as deposited. The TiO₂ may be annealed in air to eliminate oxygen vacancies. The conductive metal dopant preferably comprises gold, silver, copper, or another suitable conductive metal dopant that has limited solubility or is insoluble in the oxide matrix material. Such conductive metal dopants preferably form metal nanoparticles that can cause plasma resonance at particle-matrix interfaces (interface plasma resonance). More preferably, the conductive metal dopant comprises gold. The gold may be in the form of discrete gold nanoparticles insoluble within the oxide matrix material, such as TiO₂. Gold is not soluble in the TiO₂ matrix so it forms free metal islands or particles. The gold nanoparticles may have a diameter in the range of 5 nanometers (nm) to 100 nm. Preferably, the gold nanoparticles may have a diameter in the range of 50 nm to 75 nm. Gold is a preferred conductive metal dopant in the feasibility experiment, discussed below, because gold does not oxidize and therefore it retains its metallic character when deposited along with TiO₂. Other metals, such as copper, silver, or another suitable metal, may be deposited as metallic nanoparticles together with TiO₂ under appropriate deposition conditions. In this embodiment of the method, the substrate is cleaned, and the TiO₂ and conductive metal dopant, such as gold, are deposited simultaneously onto the clean substrate. The TiO₂ and gold mix as they are deposited onto the substrate, and the mixture deposits on the substrate. The preferred dopant concentration may be in the range of 1.0% to 10.0%.

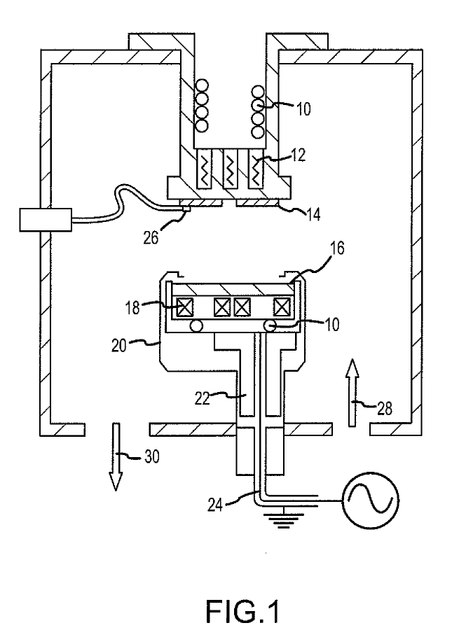

Depositing of the oxide matrix material and conductive metal dopant may be carried out with a conventional deposition method and apparatus. Such deposition methods and apparatuses that may be used may comprise physical vapor deposition, such as sputter deposition, pulsed laser deposition, electron beam physical vapor deposition, evaporative deposition, and cathodic arc deposition, or chemical vapor deposition, or sol-gels, or another suitable deposition method and apparatus. FIG. 1 is a schematic diagram of one of the embodiments of a deposition apparatus that may be used to produce the infrared-reflecting films of the disclosure. FIG. 1 shows a sputter deposition apparatus, and in particular, a magnetron sputtering chamber that may be used as one of the methods to deposit and produce the infrared-reflecting films of the disclosure. Sputter deposition deposits the material or film by sputtering or ejecting material from a target, i.e., source, which then deposits onto the substrate. With a magnetron sputtering deposition process or device, the preferred substrates are glass and silicon or another nonvolatile solid suitable for application requirements. The sputtering gas used is preferably an inert gas such as argon, and oxygen is also preferably used. By example, oxygen may be used to oxidize the titanium (Ti) to produce TiO₂. In one of the embodiments, the gold (Au) wires are inserted in the Ti sputtering target. For example, four or six evenly spaced gold wires may be placed in the Ti sputtering target track to dope TiO₂ films with gold nanoparticles. The substrate bias is preferably −150 Volts (V), with a pulse rate of 150 kiloHertz (kHz). The deposition rates may be 8 nanometers/minute (nm/min) at 250 Watts (W) target power, or 3.9 nm/min at 175 W target power. The magnetron sputtering does not result in significant heating of the substrate, and thus substrates that do not normally survive higher temperatures may be used with this method. As shown in FIG. 1, the sputtering chamber may comprise water cooling elements 10, heating resistors 12, substrates 14, target 16, permanent magnets 18, shield 20, insulator 22, RF (radio frequency) cable 24, thermocouple 26, gas inlet 28, and pumping system 30. The length of time of the deposition depends on various parameters, including how much power is applied to the target, how close the substrate is to the target (i.e., typically the closer the target to the substrate, the faster the deposition), and other parameters. For an infrared-reflecting film having a thickness in the range of 300 nanometers (nm) (0.3 micron) to 500 nm (0.5 micron), the deposition time is typically only a few hours. In some instances, it may be necessary to add oxygen after the deposition. Annealing adds oxygen to a substoichiometric film. The annealing step may be optional depending on the type of film and parameters used.

The method further comprises step 46 (FIG. 4) of producing an infrared-reflecting film. In one of the embodiments, the infrared-reflecting film may have a thickness in the range of 0.3 micron to 10 microns. Preferably, the infrared-reflecting film may have a thickness in the range of 0.5 micron to 2 microns. However, the infrared-reflecting film may have other suitable thicknesses as well. The infrared-reflecting film has a greater reflectivity in an infrared waveband of greater than 800 nanometers in wavelength than a film without the conductive metal dopant, and in particular, in an infrared waveband of 800 nm to 2500 nm where the metal dopant is gold.

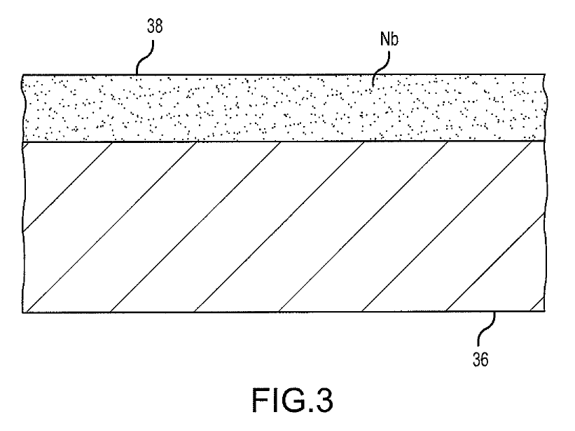

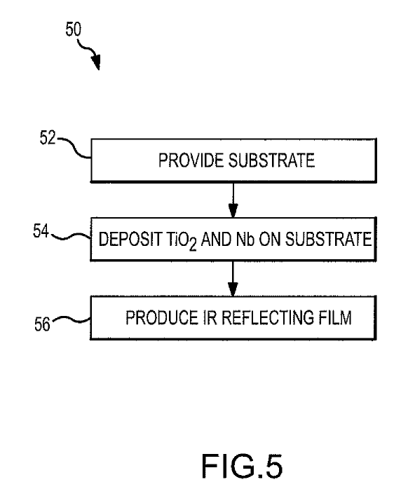

In another one of the embodiments of the disclosure, there is provided a method for making a single layer infrared-reflecting film. Preferably, the film is transparent. FIG. 3 is a cross-sectional view of another one of the embodiments of the infrared-reflecting films of the disclosure. FIG. 3 shows a substrate 36 and a single layer 38 comprising a mixture of an oxide matrix material, such as TiO₂, and a higher valence cation, such as niobium (Nb), discussed in further detail below. FIG. 5 is a block flow diagram of another one of the embodiments 50 of the method of the disclosure. The method comprises step 52 (FIG. 5) of providing a substrate. As discussed above, the substrate may comprise glass, semiconductor (e.g., silicon), ceramic (including cement-based material), enamel, metal, composite, laminate, or another suitable substrate. The type of substrate used depends on the type of measurements desired and on the type of deposition method and apparatus used.

The method further comprises step 54 (FIG. 5) of depositing onto the substrate a mixture of an oxide matrix material and a higher valence cation or substitutional dopant. The oxide matrix material may comprise titanium dioxide, zinc oxide, tin oxide, or another suitable oxide matrix material that is transparent in the visible region. The higher valence cation or substitutional dopant may comprise niobium, vanadium, tantalum, tungsten, chromium, or another suitable higher valence cation. Such higher valence cations have a higher valence than Ti and can donate excess electrons that occupy the conduction band. The preferred higher valence cation is niobium (Nb). The Nb is preferably dissolved in the oxide matrix material, such as TiO₂, rather than being insoluble such as the gold. For example, Nb⁵⁺ is the closest in ionic radius to Ti⁴⁺ (0.070 nm vs. 0.068 nm). Moreover, Nb has a variety of ionization states. In one of the embodiments Nb wires are inserted in the Ti sputtering target. For example, Nb wires may be placed symmetrically in the Ti target sputtering track to introduce Nb atoms into TiO₂. The substrate bias is preferably −150 Volts (V), with a pulse rate of 150 kiloHertz (kHz). The deposition rate may be 3.3 nanometers/minute (nm/min) at 175 Watts (W) target power. The substrate is cleaned, and the TiO₂ and Nb are deposited simultaneously onto the clean substrate. The TiO₂ and Nb mix as they are deposited onto the substrate, and the mixture is deposited onto the substrate. By adjusting the dopant concentration, the critical frequency or wavelength of reflection (bulk plasma resonance), can be controlled. The preferred dopant concentration may be in the range of 1.0% to 10.0%.

Depositing of the oxide matrix material and the higher valence cation may be carried out with a conventional deposition method and apparatus, such as discussed above. Such deposition methods and apparatuses that may be used may comprise physical vapor deposition such as sputter deposition (see FIG. 1), pulsed laser deposition, electron beam physical vapor deposition, evaporative deposition, and cathodic arc deposition, or chemical vapor deposition, or sol-gels, or another suitable deposition method and apparatus.

The method further comprises step 56 (FIG. 5) of producing an infrared-reflecting film. In one of the embodiments, the infrared-reflecting film may have a thickness in the range of 0.3 micron to 10 microns. Preferably, the infrared-reflecting film may have a thickness in the range of 0.5 micron to 2 microns. However, the infrared-reflecting film may have other suitable thicknesses as well. The infrared-reflecting film has a greater reflectivity in an infrared waveband of greater than 800 nanometers in wavelength than a film without the higher valence cation, and in particular, in an infrared waveband of 800 nm to 2500 nm where the higher valence cation is niobium.

In another embodiment of the disclosure there is provided a single layer infrared-reflecting film with enhanced reflectivity in an 800 nanometer to 2500 nanometer infrared waveband. The film comprises a mixture of an oxide matrix material and a conductive metal dopant over a substrate. The oxide matrix material may comprise titanium dioxide, zinc oxide, tin oxide, or another suitable oxide matrix material that is transparent in the visible region. The conductive metal dopant preferably comprises gold, silver, copper, or another suitable conductive metal dopant that has limited solubility or is insoluble in the oxide matrix material. More preferably, the conductive metal dopant comprises gold. The gold may be in the form of discrete gold nanoparticles insoluble within the oxide matrix material, such as TiO₂. The single layer infrared-reflecting film is produced as discussed above in relation to the method regarding the titanium dioxide matrix/gold embodiment.

In another embodiment of the disclosure there is provided a single layer infrared-reflecting film with enhanced reflectivity in an 800 nanometer to 2500 nanometer infrared waveband. The film comprises a mixture of an oxide matrix material and a higher valence cation over a substrate. The oxide matrix material may comprise titanium dioxide, zinc oxide, tin oxide, or another suitable oxide matrix material that is transparent in the visible region. The higher valence cation may comprise niobium, vanadium, tantalum, tungsten, chromium, or another suitable higher valence cation. The preferred higher valence cation is niobium. The substrate is as discussed above. The single layer infrared-reflecting film is produced as discussed above in relation to the method regarding the titanium dioxide matrix/niobium embodiment.

### EXAMPLE 1

TiO₂ film with gold (Au) was synthesized by magnetron sputtering onto a silicon substrate and glass cover slip. The substrate was ultrasonically cleaned in acetone for 15 minutes followed by cleaning in methanol for 15 minutes. The substrate was then placed in a vacuum chamber, with a base pressure of less than 5.0×10⁻⁸ Torr. The substrate was sputter-cleaned at a voltage of −150 Volts (V) in an argon atmosphere of 50 mTorr for 5 minutes. Then the deposition was carried out at 175 Watts (W) of power on a 2-inch diameter titanium target with inserted Au wires, pulsing at 250 kiloHertz (kHz). The substrate bias during deposition was −150 V, pulsing at 150 kHz. The sputtering atmosphere was 75% argon and 25% oxygen, with a total pressure of 5 mTorr. Final film thickness was around 300 nm (0.3 micron) to 500 nm (0.5 micron). Because of problems associated with oxygen flow control in some experiments, the TiO₂ films were often substoichiometric. This problem was solved by annealing in air at 450° C. for 2 hours. This annealing step was not required for stoichiometric films. The resulting film was analyzed for composition, structure, and optical properties.

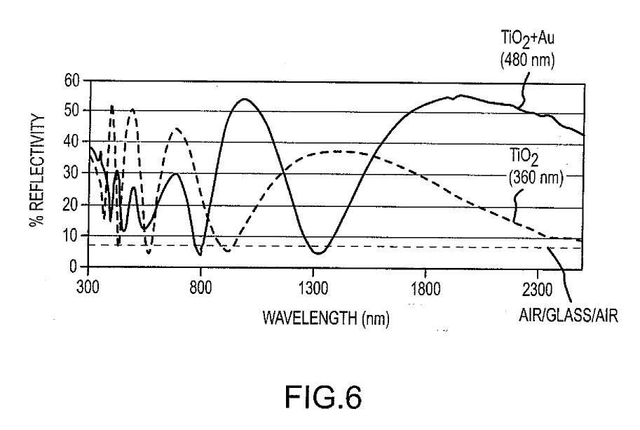

FIG. 6 is a graph showing percent reflectivity of one of the embodiments of the infrared-reflecting films containing gold (Au) nanoparticles, and in particular, Example 1. FIG. 6 shows the reflectivity behavior of the film with gold (Au) nanoparticles annealed at 450° C. for 2 hours versus the reflectivity of a plain annealed TiO₂ film. A line showing the reflectivity of an air/glasslair interface with no film is also shown. The reflectivity in the IR waveband (greater than 800 nm wavelength) for the film with gold nanoparticles is enhanced, over that without gold nanoparticles, or a normal piece of glass.

According to energy-dispersive x-ray spectrometry (EDS), gold doping varied from 0.7-1.3 at. % (atomic percent) in doped films when four gold wires were used. Gold doping varied from 1.8-2.0 at. % in doped films when six gold wires were used (see FIG. 6). Varying conditions such as substrate voltage or frequency did not seem to have an effect on the amount of gold. Differences in gold doping may have been due to slightly different alignments of gold wires with Ti in the track. Gold sputters at a faster rate than Ti. The deposited films were very smooth, and the reflectance spectra showed characteristic interference patterns and fairly high transmittance values in the infrared waveband of greater than 800 nm in wavelength. The gold doped film showed up to 50% reflectance in an infrared waveband of greater than 800 nm in wavelength, whereas undoped film showed up to 20% in an infrared waveband of greater than 800 nm in wavelength. Because of the problems associated with oxygen flow control in some experiments, the TiO₂ films were often substoichiometric. This problem was solved by annealing in air at 450° C. for 2 hours. This annealing step was not required for stoichiometric films. The resulting film was analyzed for composition, structure, and optical properties.

### EXAMPLE 2

TiO₂ film with niobium (Nb) was synthesized by magnetron sputtering onto a silicon substrate and glass cover slip. The substrate was ultrasonically cleaned in acetone for 15 minutes followed by cleaning in methanol for 15 minutes. The substrate was then placed in a vacuum chamber, with a base pressure of less than 5.0×10⁻⁸ Torr. The substrate was sputter-cleaned at a voltage of −150 Volts (V) in an argon atmosphere of 50 mTorr for 5 minutes. Then the deposition was carried out at 175 Watts (W) of power on a 2-inch diameter titanium target with inserted Nb wires, pulsing at 250 kiloHertz (kHz). The substrate bias during deposition was −150V, pulsing at 150 kHz. The sputtering atmosphere was 75% argon and 25% oxygen, with a total pressure of 5 mTorr. Final film thickness was around 300 nm (0.3 micron) to 500 nm (0.5 micron). Because of problems associated with oxygen flow control in some experiments, the TiO₂ films were often substoichiometric. This problem was solved by annealing in air at 450° C. for 2 hours. This annealing step was not required for stoichiometric films. The resulting film was analyzed for composition, structure, and optical properties.

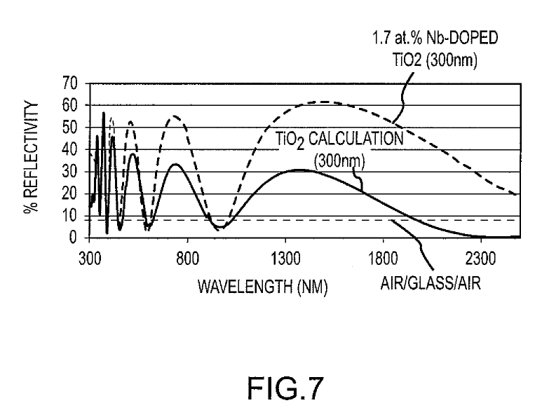

FIG. 7 is a graph showing percent reflectivity of one of the embodiments of the infrared-reflecting films containing niobium (Nb), and in particular, Example 2. FIG. 7 shows similar data for TiO₂ films with niobium (Nb) doping of approximately 1.7% and without. Approximately 45% enhancement in reflectivity at interference maximum in IR regime for glass substrate was shown. Overall, approximately 33% of spectral energy in the 800 nm to 2500 nm IR waveband was reflected. The reflectivity at wavelengths of 1100 nanometers (nm) and greater were enhanced by the addition of Nb.

EDS confirmed the presence of Nb. An AFM (atomic force microscope) 10 micron scan showed a smooth film and an RMS (root mean square) roughness of 2.6 nanometers (nm). A mixture of rutile/anatase TiO₂ films doped with Nb was deposited. The extinction coefficient of films was near zero in visible and 800 nm to 2500 nm IR waveband. A 33% reflection of spectral radiation in the 800 nm to 2500 nm IR waveband was observed.

Many modifications and other embodiments of the disclosure will come to mind to one skilled in the art to which this disclosure pertains having the benefit of the teachings presented in the foregoing descriptions and the associated drawings. The embodiments described herein are meant to be illustrative and are not intended to be limiting. Although specific terms are employed herein, they are used in a generic and descriptive sense only and not for purposes of limitation.

What is claimed is:

1. A method for making a single layer infrared-reflecting film comprising the steps of:
providing a substrate;
depositing onto the substrate a mixture of an oxide matrix material and a conductive metal dopant; and,
producing the infrared-reflecting film.

2. The method of claim 1 wherein the substrate is a material selected from the group consisting of glass, silicon, ceramic, cement-based material, enamel, metal, composite, and laminate.

3. The method of claim 1 wherein the oxide matrix material is selected from the group consisting of titanium dioxide, zinc oxide, and tin oxide.

4. The method of claim 1 wherein the conductive metal dopant is selected from the group consisting of gold, silver, and copper.

5. The method of claim 1 wherein the conductive metal dopant comprises gold nanoparticles insoluble in the oxide matrix material.

6. The method of claim 1 wherein the infrared-reflecting film has a thickness in the range of 0.3 micron to 10 microns.

7. The method of claim 1 wherein the infrared-reflecting film has a greater reflectivity in an infrared waveband of greater than 800 nanometers in wavelength than a film without the conductive metal dopant.

8. A method for making a single layer infrared-reflecting film comprising the steps of:
providing a substrate;
depositing onto the substrate a mixture of an oxide matrix material and a higher valence cation; and, producing the infrared-reflecting film.

9. The method of claim 8 wherein the substrate is a material selected from the group consisting of glass, silicon, ceramic, cement-based material, enamel, metal, composite, and laminate.

10. The method of claim 8 wherein the oxide matrix material is selected from the group consisting of titanium dioxide, zinc oxide, and tin oxide.

11. The method of claim 8 wherein the higher valence cation is selected from the group consisting of niobium, vanadium, tantalum, tungsten, and chromium.

12. The method of claim 8 wherein the higher valence cation is niobium.

13. The method of claim 8 wherein the infrared-reflecting film has a thickness in the range of 0.3 micron to 10 microns.

14. The method of claim 8 wherein the infrared-reflecting film has a greater reflectivity in an infrared waveband of greater than 800 nanometers in wavelength than a film without the higher valence cation.

15. A single layer infrared-reflecting film with enhanced reflectivity in an 800 nanometer to 2500 nanometer infrared waveband, the film comprising a mixture of an oxide matrix material and a conductive metal dopant over a substrate.

16. The film of claim 15 wherein the oxide matrix material is selected from the group consisting of titanium dioxide, zinc oxide, and tin oxide.

17. The film of claim 15 wherein the conductive metal dopant is selected from the group consisting of gold, silver, and copper.

18. A single layer infrared-reflecting film with enhanced reflectivity in an 800 nanometer to 2500 nanometer infrared waveband, the film comprising a mixture of an oxide matrix material and a higher valence cation over a substrate.

19. The film of claim 18 wherein the oxide matrix material is selected from the group consisting of titanium dioxide, zinc oxide, and tin oxide.

20. The film of claim 18 wherein the higher valence cation is selected from the group consisting of niobium, vanadium, tantalum, tungsten, and chromium.
